(19) United States
(12) Patent Application Publication
(10) Pub. No.: US 2024/0151995 A1
(43) Pub. Date: May 9, 2024

(54) ADAPTIVE COLOR CHANGE SYSTEMS TO PERSONALIZE PRODUCTS

(71) Applicant: Sony Group Corporation, Tokyo (JP)

(72) Inventors: Anthony ROBERTS, Stuttgart (DE); Diana HENNIG, Stuttgart (DE); Gabriele NELLES, Stuttgart (DE); Silvia ROSSELLI, Stuttgart (DE); Elham KHODABAKHSHI SHALAMZARI, Stuttgart (DE); Tomoaki TAKUMA, Stuttgart (DE); Asami YAMAGISHI, Stuttgart (DE); Shigeaki SUZUKI, Stuttgart (DE); Simon HENNING, Stuttgart (DE); Rikke GERTSEN CONSTEIN, Stuttgart (DE)

(73) Assignee: Sony Group Corporation, Tokyo (JP)

(21) Appl. No.: 18/284,304

(22) PCT Filed: Mar. 14, 2022
(86) PCT No.: PCT/EP2022/056544

§ 371 Date: Sep. 27, 2023

(30) Foreign Application Priority Data
Mar. 31, 2021 (EP) 21166296.0

(51) Int. Cl. G02F 1/01; C08K 5/3432; C08K 5/42; C09K 9/02; G02F 1/13; G02F 1/155

(52) U.S. Cl. CPC G02F 1/0147; C08K 5/3432; C08K 5/42; C09K 9/02; G02F 1/132; G02F 1/155; C09K 2211/1007; C09K 2211/1018

(57) ABSTRACT

The field of the DISCLOSURE lies in personalization of products for enhanced user experience. The present disclosure relates to color change systems and their use in devices or objects that are consumer products, parts of a building or vehicle, consumer electronic devices, household appliances or pieces of furniture. The present disclosure also relates to said devices or objects including such color change systems.

### BACKGROUND

The field of the DISCLOSURE lies in personalization of products for enhanced user experience.

The present disclosure relates to color change systems and their use in devices or objects that are consumer products, parts of a building or vehicle, consumer electronic devices, household appliances or pieces of furniture.

The present disclosure also relates to said devices or objects including such color change systems.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Consumer products are currently designed with their specific and fixed color appearance. The optics of these products can only be changed by buying another product or in some cases encasing them into an outer shell, such as a case for a smartphone. However, no intrinsic color change of products is currently available.

### SUMMARY

In the following, the elements of the invention will be described. These elements are listed with specific embodiments, however, it should be understood that they may be combined in any manner and in any number to create additional embodiments. The variously described examples and preferred embodiments should not be construed to limit the present invention to only the explicitly described embodiments. This description should be understood to support and encompass embodiments which combine two or more of the explicitly described embodiments or which combine the one or more of the explicitly described embodiments with any number of the disclosed and/or preferred elements. Furthermore, any permutations and combinations of all described elements in this application should be considered disclosed by the description of the present application unless the context indicates otherwise.

The present disclosure provides the use of a system comprising stimulus-reactive component(s) or of liquid crystal material for color change, wherein the color change is due to an external stimulus selected from change of temperature, change of voltage, change of pressure, change of bending, change of viewing angle, and/or movement.

The present disclosure provides a method for generating a color change system, which changes color due to a change of temperature, said color change system to be incorporated in a device or object as defined herein, said method comprising
(a) mixing a thermochromic material, or thermochromic liquid crystal(s), with a matrix, preferably a polymer matrix,
(b) coating a substrate with the mixture obtained in step (a), wherein the substrate is a conductive substrate or a substrate coated with a conductive material, preferably a thin film heater (TFH), wherein the substrate forms part of the device or object as defined herein.

The present disclosure provides a method for generating a color change system, which changes color due to a change of temperature, said color change system to be incorporated in a device or object as defined herein, said method comprising,
(a) mixing a thermochromic material, or thermochromic liquid crystal(s), with a matrix, preferably a polymer matrix,
(b) adding electro-to-thermal conversion element(s) or the electro thermal agent(s), to the mixture obtained in step (a),
(c) optionally, coating a substrate with the mixture obtained in step (b), wherein the substrate forms part of the device or object as defined herein.

The present disclosure provides a device or object selected from:
a consumer product, in particular an item for personal use or consumption,
a part of a building or vehicle,
a piece of furniture,
a consumer electronic device,
a household appliance,
   wherein said device or object comprises a color change system as defined herein.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a color change system wherein the color change is due to a change in temperature and is from a first color to a second color in a single step (FIG. 1A), or wherein the color change is from one color to many color states through intermediary color states by using different thermochromic pigments (FIG. 1B).

FIG. 2A shows a color change system wherein the color change is due to a change in temperature, which comprises a matrix, thermochromic material and electro-to-thermal conversion elements.

FIG. 2B shows that depending from the patterning of the electro-to-thermal conversion elements, the color effect can be homogenous or patterned.

FIGS. 3A and B show color change in textiles with different patterns.

FIG. 4A shows thermal bi-coloring.

FIG. 4B shows thermal LC.

FIG. 5 shows the switch-on effect in a co-planar and a vertical device stack of a color change system based on conductive polymer wherein the color change is due to a change of voltage.

FIG. 6 shows joining of different colors in a color change system based on conductive polymer and metal-complex pigment wherein the color change is due to a change of voltage.

FIG. 7A shows various color states which can be obtained from a multicolor ECD stack based on viologen at different voltages. FIG. 7B shows a 2D-plot of CIELAB color coordinates (a*, b*) of the viologen based ECDs by using a software ‘ColorCalculator’ developed by OSRAM SYLVANIA Inc. FIG. 7C shows the UV-Vis absorption spectra of the device made by blending two viologens in one EC gel at various applied potentials.

FIG. 8 shows the structure of a device stack of a color change system using liquid crystal (LC) materials.

FIG. 9 shows photographs of static color of LC operating at different voltage.

FIG. 10A shows photographs of a flexible stack containing LC producing different polarisation colors. The different pictures show color produced by different viewing positions, with 10B showing the effect of bending the stack by hand (from the flat state to a bent state with a bend of radius ˜10 cm) thus the colour of the system perceived by the viewer was varied.

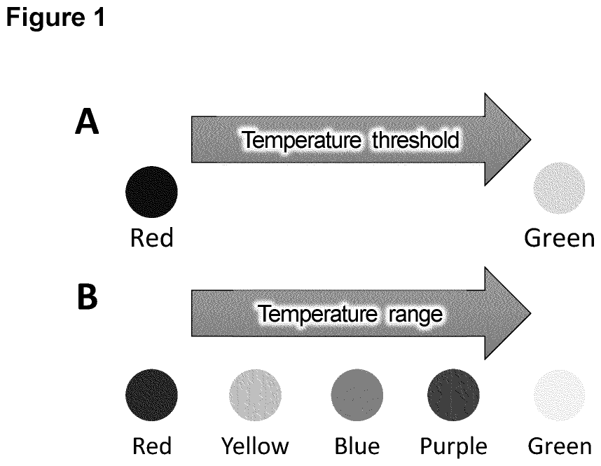

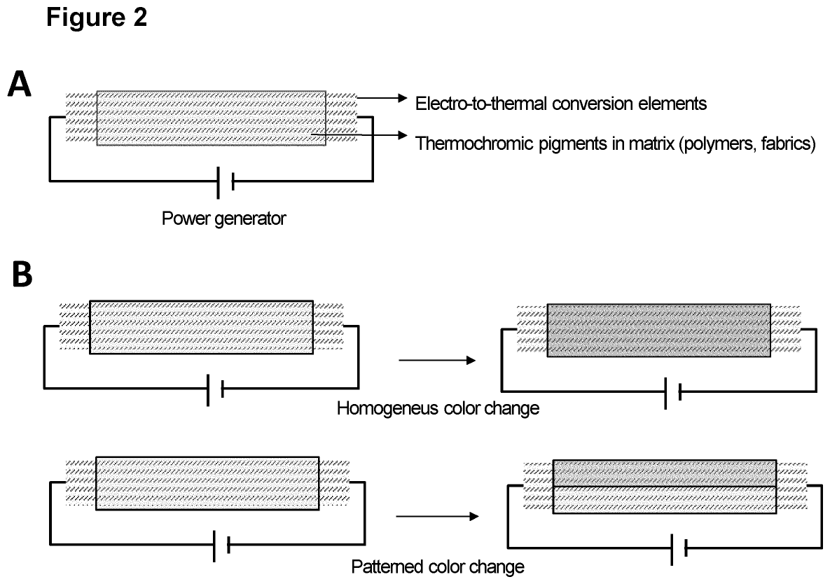

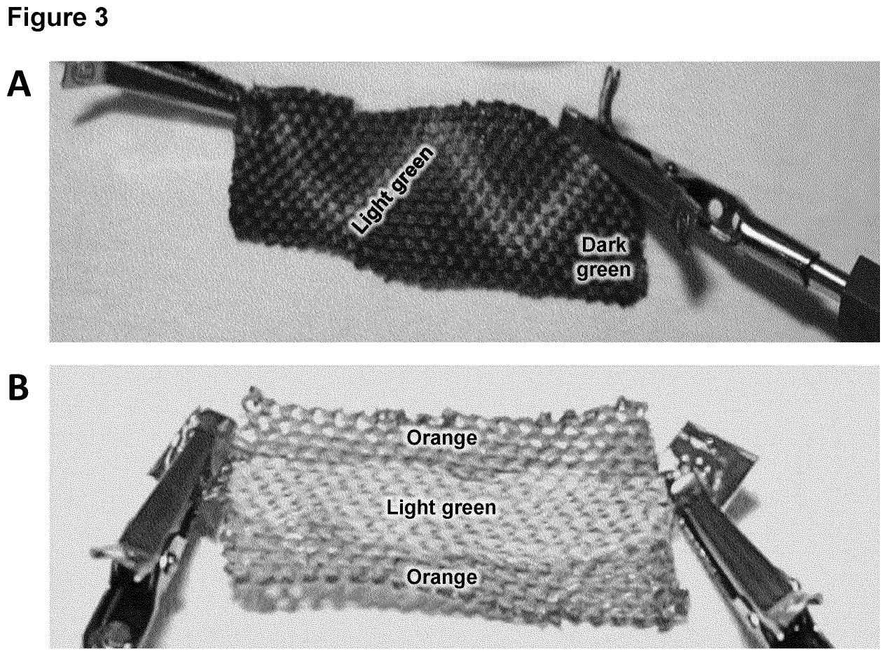

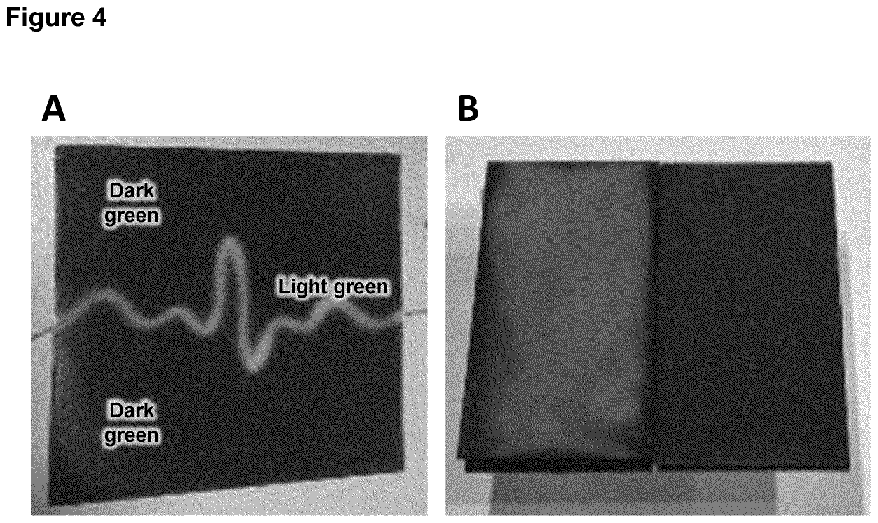

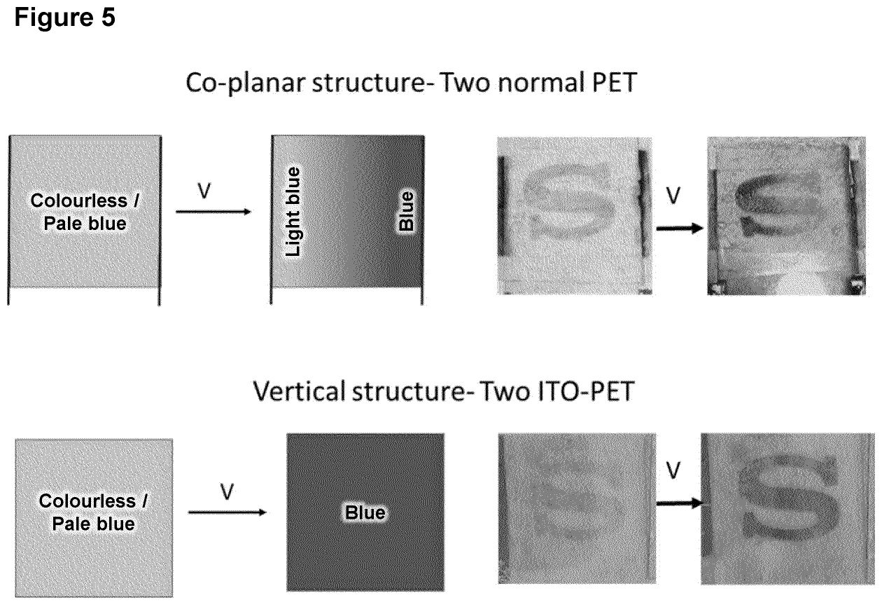

### DETAILED DESCRIPTION OF THE EMBODIMENTS

As discussed above, the present disclosure provides the use of a system comprising stimulus-reactive component(s) or of liquid crystal material for color change, wherein the color change is due to an external stimulus selected from change of temperature, change of voltage, change of pressure, change of bending, change of viewing angle, and/or movement.

In a preferred embodiment, said color change system is comprised in/on a device or object.

Said device or object is selected from a consumer product, a part of a building or vehicle, a piece of furniture, a consumer electronic device, a household appliance.

In a preferred embodiment, said device or object is a consumer product, in particular an item for personal use or consumption.

Examples are a piece of clothing, jewelry, wristwatch, dishware, and shoes.

In a preferred embodiment, said device or object a part of a building or a part of a vehicle.

Examples are a window, in particular, a home window, shared house or office window, a car window. Further examples are a wall, a ceiling, a floor, and a pillar.

In a preferred embodiment, said device or object is a piece of furniture.

Examples are a table, a chair, a desk, a stool, a bed, a shelf, and a wardrobe.

In a preferred embodiment, said device or object is a consumer electronic device.

Examples are a mobile phone, a computer, headphones, a speaker, a robotic device, a TV set, a stereo set, an electronic toy, and a game console.

In a preferred embodiment, said device or object is a household appliance.

Examples are a dishwasher, washing machine, drying machine, an iron, and a hairdryer.

Preferably, said color change is in/on at least one surface of said device or object.

In one embodiment, said external stimulus is not exerted by said device or object.

In one embodiment, said external stimulus is exerted by said device or object.

In a preferred embodiment, the stimulus is a change of temperature.

In such embodiment, the color change system comprises
(i) thermochromic material,
   such as thermochromic pigment(s) or ink(s), or thermochromic liquid crystal(s),
(ii) electro-to-thermal conversion element(s) or electro thermal agent(s), such as metal(s),
(iii) a matrix, such as polymer(s), fabric(s), or resin(s)
(iv) optionally, a substrate.

The color change can be from a first color to a second color in a single step, or the color change can be from one color to many color states/through intermediary color states, preferably by using different pigments.

The color effect can be homogenous or patterned.

In one embodiment, the (i) thermochromic material is selected from leuco dye systems or inorganic thermochromic pigments.

Leuco dye systems include spirolactones, fluorans, spiropyrans, and fulgides, including acids, such as bisphenol A, parabens, 1,2,3-triazole derivates, and 4-hydroxycoumarin, acting as proton donors, changing the dye molecule between its leuco form and its protonated colored form.

Inorganic thermochromic pigments include titanium dioxide, zinc sulfide, zinc oxide, cuprous mercury iodide and silver mercury iodide.

The thermochromic liquid crystal(s) include cholesteric liquid crystal, such as cholesteryl nonanoate; or cyanobiphenyls.

Preferably, said thermochromic materials are in the form of pigment powder, dispersion in solvent or granulates.

In one embodiment, the (ii) electro-to-thermal conversion element(s) or electro thermal agent(s) are conductive/metal wires of micro or nano size, conductive/metal rods of micro or nano size, conductive/metal foil or mesh or conductive polymer(s),

such as
conductive/metal wires, rods, foil or mesh of CuSn, e.g. CuSn mesh, CuSn foil, CuSn wire, steel thread,
thin film heaters (TFH), e.g. silver nanowire, copper nanowire, conductive polymer poly(3,4-ethylenedioxythiophene)-poly(styrenesulfonate) (PEDOT:PSS).

In one embodiment, the thermochromic material (i), preferably thermochromic pigment(s) or ink(s), is embedded in a matrix (iii), wherein the matrix is a polymer matrix, and wherein preferably electro-to-thermal conversion element(s) or the electro thermal agent(s) (ii) are implemented in the thermochromic material/polymer matrix.

The polymer matrix can be poly(methyl methacrylate (PMMA), poly-di-methyl-siloxane (PDMS), styrene-base copolymer, or polyurethane (PU).

In one embodiment, the mixture of thermochromic material and polymer matrix is used as top-coat material for substrates.

Preferably, the substrate (iii) is non-conductive, such as glass, polyethylene terephthalate (PET),
or the substrate is conductive (iii), such as conductive fabric, metal plates, metal grids, metal mesh, glass or PET substrate with metal nanowires, glass or PET substrate with conductive polymer.

Preferably, the surface of the substrate is rigid, planar, has curves, or the surface of the substrate is flexible.

In one embodiment, furthermore a sensor and/or a microcontroller are comprised to trigger the color change function.

In one embodiment, the color switching procedure is controllable via wireless triggering such as Bluetooth (BT).

In one embodiment, said color change occurs at a rate, wherein said rate is fixed or wherein said rate is variable.

As discussed above, the present disclosure provides a method for generating a color change system, which changes color due to a change of temperature, said color change system to be incorporated in a device or object as defined herein.

Said method comprises
(a) mixing a thermochromic material, or thermochromic liquid crystal(s), preferably as defined herein, with a matrix, preferably a polymer matrix, such as defined herein,
(b) coating a substrate, preferably as defined herein, with the mixture obtained in step (a), wherein the substrate is a conductive substrate or a substrate coated with a conductive material, preferably a thin film heater (TFH), such as defined herein, wherein the substrate forms part of the device or object as defined herein.

As discussed above, the present disclosure provides a further method for generating a color change system, which changes color due to a change of temperature, said color change system to be incorporated in a device or object as defined herein.

Said method comprises
(a) mixing a thermochromic material, or thermochromic liquid crystal(s), preferably as defined herein,
with a matrix, preferably a polymer matrix, such as defined herein,
(b) adding electro-to-thermal conversion element(s) or the electro thermal agent(s), preferably as defined herein, to the mixture obtained in step (a),
(c) optionally, coating a substrate with the mixture obtained in step (b), wherein the substrate forms part of the device or object as defined herein.

In a preferred embodiment, the stimulus is a stimulus is a change of voltage.

In such embodiment, the color change system comprises an electrochromic cell or an electrochromic device (ECD).

In such embodiment, the color change comprises opacity change.

The ECD preferably comprises:
at least one electrochromic (EC) layer,
an electrolyte layer,
two (transparent) conducting electrodes.

The electrodes can be glass or polyethylene terephthalate (PET), each coated with indium tin oxide (ITO) and/or other doped metal oxide(s).

The color effect can be homogenous or patterned. For example, the color effect is homogenous from color 1 to color 2 or multiple colors, such as color 1 to color 2 to color 3 or more. For example, the color effect is patterned

Preferably, the at least one EC layer comprises
(i) conductive polymer(s),
   such as poly(3,4-ethylenedioxythiophene)-poly(styrenesulfonate) (PEDOT:PSS)-based materials,
   optionally mixed with one or more metal-complex pigment(s), or
   optionally as an electrochromic layer in a multi-layer stack, or
(ii) small organic molecule(s),
   such as viologen,
   e.g. alkyl-substituted viologens
      monoheptyl viologen hexafluorophosphate [MHV(PF₆)],
      diheptyl viologen bis-(hexafluorophosphate) [DHV(PF₆)₂],
      ethyl viologen bis-(hexafluorophosphate) [EV(PF₆)₂],
      or combinations thereof, such as DHV(PF₆)₂ and MHV(PF₆)₂ aryl-substituted viologens or EV(PF₆)₂ and MHV(PF₆)₂.

In one embodiment, the at least one EC layer comprises (i) conductive polymer(s) and the system has a vertical structure or a co-planar structure.

Said vertical structure comprises preferably from top to bottom:
an (transparent) conducting electrode,
an EC layer,
a spacer, preferably a bi-adhesive spacer,
an electrolyte layer,
an EC layer, and
an (transparent) conducting electrode.

Said co-planar structure comprises preferably from top to bottom
a substrate,
an electrolyte layer,
a spacer, preferably a bi-adhesive spacer,
an EC layer,
a layer containing (transparent) conducting electrodes, and
a substrate.

In one embodiment, the at least one EC layer comprises (ii) viologen(s) and the system furthermore comprises
an anodic species,
   such as ferrocene (Fc),
an ionic liquid,
   such as 1-ethyl-3-methylimidazolium bis(trifluoromethylsulfonyl)imide ([EMI][TFSI]), 1-ethyl-3-methylimidazolium tetrafluoroborate ([EMI][BF₄]), a copolymer,
   such as poly(vinylidene fluoride-co-hexafluoropropylene) (PVDF-co-HFP).

Preferably, a mixture of the copolymer, the ionic liquid, the viologen (such as DHV(PF₆)₂ or MHV(PF₆)₂ or EV(PF₆)₂ and the anodic species (such as dmFc) are cast onto a substrate, preferably an ITO-coated substrate, and another substrate, preferably an ITO-coated substrate, is placed on top.

Preferably, the surface of the substrate is rigid, planar, has curves, or the surface of the substrate is flexible.

In one embodiment, furthermore a sensor and/or a microcontroller are comprised to trigger the color change function.

In one embodiment, the color switching procedure is controllable via Bluetooth.

In one embodiment, said color change occurs at a rate, wherein said rate is fixed or wherein said rate is variable.

A preferred embodiment comprises the use of liquid crystal (LC) materials.

In such embodiment, the LC materials are preferably in a device stack comprising polarizer(s), substrate(s), electrode(s), alignment layer(s) and said LC material(s).

Preferably, said use is for generating fluid color or rainbow or stained-glass effects.

Preferably, the color change is performed by applying a voltage with a modulated waveform,

wherein more preferably shape, amplitude, and/or frequency of the waveform is modulated.

In one embodiment, a device stack of a LC cell has the following layer structure from top to bottom:
(i) polarizer/analyser,
(ii) substrate, such as glass, silicone, plastic (e.g. PET),
(iii) electrode, such as ITO, ICP (e.g. PEDOT:PSS),
(iv) alignment layer, optionally alignment and passivation layer,
(v) LC material layer,
   optionally comprising spacers and/or sealant,
(vi) electrode, such as ITO, Al, Ag, ICP (e.g. PEDOT:PSS),
(vii) substrate, such as glass, silicone, plastic (e.g. PET),
(ix) polarizer/waveplate, and
(x) light source or mirror or white selective reflection light gathering.

The LCs in said LC material layer (v) have the following characteristics:
having the property of birefringence;
having positive or negative dielectric anisotropy;
being a mixture of molecules or a single molecule;
their phase is nematic or smectic or chiral or blue or discotic or columnar or conic or isostropic, or selectable between phases;
the LC class is thermotropic, lyotropic or metallotropic; and
the directors of the LC in the layer are random, vertical, parallel, bent, or twisted.

Preferably, one device stack is a single pixel, and/or one device stack is conformable.

In one embodiment, the alignment layer creates patterns.

In one embodiment, different alignment of LCs are comprised within an area in the cm² range.

Preferably, the color effects are obtained by one or more of the following:
different LC material,
type of polarizer (linear or circular),
direction of top and bottom polarizers (co-linear, crossed or at some angle relative to each other in-between),
spacing between two electrodes or varying the LC cell gap in different parts of the LC cell, e.g. via the use of different sized spacers,
varying the alignment layer strength/direction/presence in different parts of the LC cell, e.g. via the use of different alignment materials, and/or different rubbing directions, and/or different deposition/processing/curing (e.g. polarization directions) conditions,
varying the retardation of the LC via changing the electric field in the LC layer,
varying the phase of the LC e.g. nematic to isotropic, or nematic to smectic,
batik designs using sealant and/or spacers in the active LC cell area,
varying the polarization/wave-plate retardation to create patterns,
cm² range also includes mm² range (fine patterning also possible),
the viewing angle of the observer caused by the observer moving relative to the LC cell.

In one embodiment, furthermore a sensor and/or a microcontroller are comprised to trigger the color change function.

In one embodiment, the color switching procedure is controllable via Bluetooth.

In one embodiment, said color change occurs at a rate, wherein said rate is fixed or wherein said rate is variable.

As discussed above, the present disclosure provides a device or object, wherein said device or object comprises a color change system as defined herein.

Said device or object is selected from a consumer product, a part of a building or vehicle, a piece of furniture, a consumer electronic device, a household appliance.

In a preferred embodiment, the device or object of the present disclosure is a consumer product, in particular an item for personal use or consumption.

Examples are a piece of clothing, dishware, and shoes.

In a preferred embodiment, the device or object of the present disclosure is a part of a building or a part of a vehicle.

Examples are a window, in particular a home window, shared house or office window, a car window. Further examples are a wall, a ceiling, a floor, and a pillar.

In a preferred embodiment, the device or object of the present disclosure is a piece of furniture.

Examples are a table, a chair, a desk, a stool, a bed, a shelf, and a wardrobe.

In a preferred embodiment, the device or object of the present disclosure is a consumer electronic device.

Examples are a mobile phone, a computer, headphones, a speaker, a robotic device, a TV set, a stereo set, an electronic toy, and a game console.

In a preferred embodiment, the device or object of the present disclosure is a household appliance.

Examples are a dishwasher, washing machine, drying machine, an iron, and a hairdryer.

A color change is due to an external stimulus selected from change of temperature, change of voltage, change of pressure, change of bending, change of viewing angle, and/or movement.

Preferably, said color change is in/on at least one surface of said device or object.

In one embodiment, said external stimulus is not exerted by said device or object.

In one embodiment, said external stimulus is exerted by said device or object.

Note that the present technology can also be configured as described below.
(1) Use of a system comprising stimulus-reactive component(s) or of liquid crystal material for color change,
wherein the color change is due to an external stimulus selected from change of temperature, change of voltage, change of pressure, change of bending, change of viewing angle, and/or movement.
(2) The use according to embodiment (1), wherein said color change system is comprised in/on a device or object selected from:
   a consumer product, in particular an item for personal use or consumption,
      e.g. a piece of clothing, jewelry, wristwatch, dishware, shoes,
   a part of a building or vehicle,
      e.g. a window, in particular, a home window, shared house or office window, a car window; a wall, a ceiling, a floor, a pillar,
   a piece of furniture,
      e.g. a table, a chair, a desk, a stool, a bed, a shelf, a wardrobe,
   a consumer electronic device,
      e.g. a mobile phone, a computer, headphones, a speaker, a robotic device, a TV set, a stereo set, an electronic toy, a game console;
   a household appliance,
      e.g. dishwasher, washing machine, drying machine, an iron, a hairdryer, wherein, preferably, said color change is in/on at least one surface of said device or object, wherein, more preferably, said external stimulus is not exerted by said device or object or said external stimulus is exerted by said device or object.
(3) The use of any of embodiments (1) to (2), wherein the stimulus is a change of temperature, wherein the color change system comprises
   (i) thermochromic material,
      such as thermochromic pigment(s) or ink(s), or thermochromic liquid crystal(s),
   (ii) electro-to-thermal conversion element(s) or electro thermal agent(s), such as metal(s), e.g. wires or mesh,
   (iii) a matrix, such as polymer(s), fabric(s), or resin(s),
   (iv) optionally, a substrate.
(4) The use of embodiment (3), wherein the color change is from a first color to a second color in a single step,
or wherein the color change is from one color to many color states/through intermediary color states, preferably by using different pigments.
(5) The use of embodiment (3) or (4), wherein the color effect is homogenous or patterned.
(6) The use of any one of embodiments (3) to (5), wherein the (i) thermochromic material are selected from
   leuco dye systems, such as spirolactones, fluorans, spiropyrans, and fulgides, as such or in polymeric capsules,
   inorganic thermochromic pigments, such as titanium dioxide, zinc sulfide, zinc oxide, cuprous mercury iodide and silver mercury iodide,
or wherein the thermochromic liquid crystal(s) are cholesteric liquid crystal, e.g. cholesteryl nonanoate; or cyanobiphenyls,
wherein, preferably, said thermochromic materials are in the form of pigment powder, dispersion in solvent or granulates.
and/or wherein the (ii) electro-to-thermal conversion element(s) or electro thermal agent(s) are conductive/metal wires of micro or nano size, conductive/metal rods of micro or nano size, conductive/metal foil or mesh or conductive polymer(s),
such as
   conductive/metal wires, rods, foil or mesh of CuSn, e.g. CuSn mesh, CuSn foil, CuSn wire, steel thread,
   thin film heaters (TFH), e.g. silver nanowire, copper nanowire, conductive polymer poly(3,4-ethylenedioxythiophene)-poly(styrenesulfonate) (PEDOT:PSS).
(7) The use of any one of embodiments (3) to (6), wherein the thermochromic material (i), preferably thermochromic pigment(s) or ink(s), is embedded in a matrix (iii), wherein the matrix is a polymer matrix (such as poly(methyl methacrylate (PMMA), poly-di-methyl-siloxane (PDMS), styrene-base copolymer, polyurethane (PU)),
and wherein preferably electro-to-thermal conversion element(s) or the electro thermal agent(s) (ii) are implemented in the thermochromic material/polymer matrix.
(8) The use of any one of embodiments (3) to (7), wherein the mixture of thermochromic material and polymer matrix is used as top-coat material for substrates,
wherein the substrate (iii) is non-conductive, such as glass, polyethylene terephthalate (PET), or wherein the substrate is conductive (iii), such as conductive fabric, metal plates, metal grids, metal mesh, glass or PET substrate with metal nanowires, glass or PET substrate with conductive polymer,
and/or wherein the surface of the substrate is rigid, planar, has curves or wherein the surface of the substrate is flexible.
(9) A method for generating a color change system, which changes color due to a change of temperature, said color change system to be incorporated in a device or object as defined in embodiment (2), said method comprising,
   (a) mixing a thermochromic material, or thermochromic liquid crystal(s), preferably as defined in embodiment 5 with a matrix, preferably a polymer matrix, such as defined in embodiment (6),
   (b) coating a substrate, preferably as defined in embodiment (7), with the mixture obtained in step (a),
      wherein the substrate is a conductive substrate or a substrate coated with a conductive material, preferably a thin film heater (TFH) as defined in embodiment (5), wherein the substrate forms part of the device or object as defined in embodiment (2).
(10) A method for generating a color change system, which changes color due to a change of temperature, said color change system to be incorporated in a device or object as defined in embodiment (2), said method comprising,
   (a) mixing a thermochromic material, or thermochromic liquid crystal(s), preferably as defined in embodiment (5)
   with a matrix, preferably a polymer matrix, such as defined in embodiment (6),
   (b) adding electro-to-thermal conversion element(s) or the electro thermal agent(s), preferably as defined in embodiment (5), to the mixture obtained in step (a),
   (c) optionally, coating a substrate with the mixture obtained in step (b), wherein the substrate forms part of the device or object as defined in embodiment (2).
(11) The use of any of embodiments (1) to (2), wherein the stimulus is a change of voltage and wherein the color change system comprises an electrochromic cell or an electrochromic device (ECD),
and wherein the color change comprises opacity change,
wherein the ECD preferably comprises:
   at least one electrochromic (EC) layer,
   an electrolyte layer,
   two (transparent) conducting electrodes,
wherein the electrodes can be glass or polyethylene terephthalate (PET), each coated with indium tin oxide (ITO) and/or other doped metal oxide(s).
(12) The use of embodiment (11), wherein the color effect is homogenous from color 1 to color 2 or multiple colors (color 1 to color 2 to color 3 or more) or patterned.
(13) The use of embodiment (11) or (12), wherein the at least one EC layer comprises
   (i) conductive polymer(s),
      such as poly(3,4-ethylenedioxythiophene)-poly(styrenesulfonate) (PEDOT:PSS)-based materials,
      optionally mixed with one or more metal-complex pigment(s), or
      optionally as an electrochromic layer in a multi-layer stack, or
   (ii) small organic molecule(s),
      such as viologen,
      e.g. alkyl-substituted viologens
         monoheptyl viologen hexafluorophosphate [MHV(PF₆)],
         diheptyl viologen bis-(hexafluorophosphate) [DHV(PF₆)₂],
         ethyl viologen bis-(hexafluorophosphate) [EV(PF₆)₂],
         or combinations thereof, such as DHV(PF₆)₂ and MHV(PF₆)₂ aryl-substituted viologens or EV(PF₆)₂ and MHV(PF₆)₂.
(14) The use of any one of embodiments (11) to (13), wherein the at least one EC layer comprises (i) conductive polymer(s) and the system has a vertical structure or a co-planar structure,
said vertical structure comprising from top to bottom:
   an (transparent) conducting electrode,
   an EC layer,
   a spacer, preferably a bi-adhesive spacer,
   an electrolyte layer,
   an EC layer, and
   an (transparent) conducting electrode,
or
said co-planar structure comprising from top to bottom
   a substrate,
   an electrolyte layer,
   a spacer, preferably a bi-adhesive spacer,
   an EC layer,
   a layer containing (transparent) conducting electrodes, and
   a substrate.
(15) The use of any one of embodiments (11) to (13), wherein the at least one EC layer comprises (ii) viologen(s) and the system furthermore comprises
   an anodic species,
      such as ferrocene (Fc),
   an ionic liquid,
      such as 1-ethyl-3-methylimidazolium bis(trifluoromethylsulfonyl)imide ([EMI][TFSI]), 1-ethyl-3-methylimidazolium tetrafluoroborate ([EMI][BF₄]), a copolymer,
      such as poly(vinylidene fluoride-co-hexafluoropropylene) (PVDF-co-HFP), wherein preferably a mixture of the copolymer, the ionic liquid, the viologen (such as DHV(PF₆)₂ or MHV(PF₆)₂ or EV(PF₆)₂ and the anodic species (such as dmFc) are cast onto a substrate, preferably an ITO-coated substrate, and another substrate, preferably an ITO-coated substrate, is placed on top.
(16) The use of any one of embodiments (11) to (15), wherein the surface of the substrate is rigid, planar, has curves or wherein the surface of the substrate is flexible.
(17) The use of any of embodiments (1) to (2), comprising the use of liquid crystal (LC) materials,
preferably in a device stack comprising polarizer(s), substrate(s), electrode(s), alignment layer(s) and LC material(s).
(18) The use of embodiment (17), for generating fluid color or rainbow or stained-glass effects.
(19) The use of embodiment (17) or (18), wherein the color change is performed by applying a voltage with a modulated waveform,
wherein preferably shape, amplitude, and/or frequency of the waveform is modulated.
(20) The use of any one of embodiments (18) to (19), wherein a device stack of a LC cell has the following layer structure from top to bottom:
   (i) polarizer/analyser,
   (ii) substrate, such as glass, silicone, plastic (e.g. PET),
   (iii) electrode, such as ITO, ICP (e.g. PEDOT:PSS),
   (iv) alignment layer, optionally alignment and passivation layer,
   (v) LC material layer,
      optionally comprising spacers and/or sealant,
   (vi) electrode, such as ITO, Al, Ag, ICP (e.g. PEDOT:PSS),
   (vii) substrate, such as glass, silicone, plastic (e.g. PET),
   (ix) polarizer/waveplate, and
   (x) light source or mirror or white selective reflection light gathering,
wherein the LCs in said LC material layer (v) have the following characteristics:
   being birefringent;
   having positive or negative dielectric anisotropy;
   being a mixture of molecules or a single molecule;
   their phase is nematic or smectic or chiral or blue or discotic or columnar or conic or isostropic, or selectable between phases;
   the LC class is thermotropic, lyotropic or metallotropic; and
   the directors of the LC in the layer are random, vertical, parallel, bent, or twisted.
(21) The use of any one of embodiments (17) to (20), wherein one device stack is a single pixel,
and/or wherein one device stack is conformable.
(22) The use of any one of embodiments (17) to (21), wherein the alignment layer creates patterns,
and/or comprising different alignment of LCs within an area in the cm² range.
(23) The use of any one of embodiments (17) to (22), wherein color effects are obtained by one or more of the following:
   different LC material,
   type of polarizer (linear or circular),
   direction of top and bottom polarizers (co-linear, crossed or at some angle relative to each other in-between),
   spacing between two electrodes or varying the LC cell gap in different parts of the LC cell, e.g. via the use of different sized spacers,
   varying the alignment layer strength/direction/presence in different parts of the LC cell, e.g. via the use of different alignment materials, and/or different rubbing directions, and/or different deposition/processing/curing (e.g. polarization directions) conditions,
   varying the retardation of the LC via changing the electric field in the LC layer,
   varying the phase of the LC e.g. nematic to isotropic, or nematic to smectic,
   batik designs using sealant and/or spacers in the active LC cell area,
   varying the polarization/wave-plate retardation to create patterns,
   cm² range also includes mm² range (fine patterning also possible),
   the viewing angle of the observer caused by the observer moving relative to the LC cell.
(24) The use any one of embodiments (17) to (23), furthermore comprising a sensor and/or a microcontroller to trigger the color change function,
and/or the color switching procedure is controllable via Bluetooth.
(25) The use of any of the preceding embodiments, wherein said color change occurs at a rate, wherein said rate is fixed or wherein said rate is variable.
(26) A device or object selected from:
   a consumer product,
      in particular an item for personal use or consumption, e.g. a piece of clothing, dishware, shoes,
   a part of a building or vehicle,
      e.g. a window, in particular, a home window, shared house or office window, a car window; a wall, a ceiling, a floor, a pillar;
   a piece of furniture,
      e.g. a table, a chair, a desk, a stool, a bed, a shelf, a wardrobe,
   a consumer electronic device,
      e.g. a mobile phone, a computer, headphones, a speaker, a robotic device, a TV set, a stereo set, an electronic toy, a game console,
   a household appliance,
      e.g. dishwasher, washing machine, drying machine, an iron, a hairdryer,
wherein said device or object comprises a color change system as defined in any of embodiments (1) to (25).
(27) The device or object of embodiment (26), wherein a color change is due to an external stimulus selected from change of temperature, change of voltage, change of pressure, change of bending, change of viewing angle, and/or movement,
wherein, preferably, said color change is in/on at least one surface of said device or object,
wherein, more preferably, said external stimulus is not exerted by said device or object or said external stimulus is exerted by said device or object.

Active and re-active adaptive material surfaces with respect to the environmental and/or the personal situation will increase the customer value, opening new possibilities for personalization, emotion expression and product utilization.

The major object of the present disclosure is creating adaptive surfaces defining new standards for the autonomous era where a shift towards product-service fusion and a cohesive delivery of products and services is expected. The object is to enhance user experience and enabling new product functionality and increasing accessibility by implementation of adaptive materials.

To reach that point the inventors applied different technologies which enable to change the material colors by applying external stimuli. Application of the technologies to different product type is disclosed to emphasize how the user experience of the product is improved. In order to reach that, the inventors use different color changing technologies aiming at end-use applications: thermochromic, electrochromic and liquid crystals, as disclosed herein.

### EXAMPLES

### Example 1: Thermochromic Based System

Silver nanowires with diameter of 115 nm and lengths of 20-50 μm and 0.5% isopropyl alcohol suspension were drop casted on the bottom of a metal mold. After drying and annealing, the mixture 20% wt of TC pigment in PDMS matrix was casted into the mold by doctor blading. The samples were baked for 2 hours at 60° C. and finally the PDMS film together with silver nanowire thin film successfully peeled off from the mold. The silver nanowire side was sealed with a protection layer to prevent oxidation. The color changing temperature depends on the used pigment but it can be occur by applying less than 4 volt.

### Example 2(a): Multicolor ECD Based on Conductive Polymers Via Two Methods System [(1) and (2)]

(1) 2 wt.-% iron oxide pigments (red and yellow), were blended with PEDOT:PSS solution. Once the PEDOT:PSS solution showing blue color was mixed with the red and yellow pigment, the colors of each mixture were changed to brownish dark red and green, respectively. Each resulting mixture was prepared by spin-coating on an ITO-glass. The cubic volume was created by the space between bottom ITO-glass and spacer. LiClO₄ based electrolyte was filled into the cubic volume that was created by a spacer with the method of drop-casting. Then, the other conductive ITO-glass was assembled.

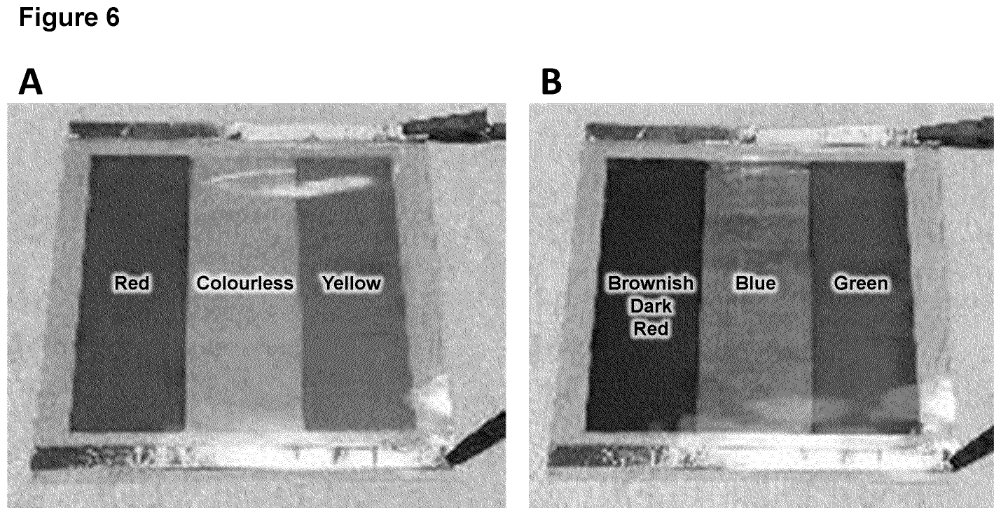

In the absorption spectra, both samples initiate coloration with the increment of absorption in the range of 600 to 700 nm at the potential of approximately −1.5V. The picture of the multicolor stack is shown in FIG. 6.

(2) As a first electrochromic layer, PEDOT:PSS aqueous solution is deposited on the bottom ITO-glass. The second electrochromic layer was prepared by mixing of Poly(methyl methacrylate) (PMMA), tetrabutylammonium hexafluorophosphate (TBAPF₆), p-Benzoquinone (p-BQ), phenol red and 2,2,6,6-Tetramethylpiperidin-1-yl)oxyl (TEMPO). The resulting solution was drop-casted on the top conductive layer. TBAPF₆ based electrolyte dissolved in acetone and PC mixture. Additionally, PMMA was added to it to increase viscosity of electrolyte. The electrolyte was then used to glue the two working and counter electrodes for ionic conduction.

After applying reduction potential, the color changes from yellow to blue and the absorption peak was detected at 640 nm. When the bias is reversed, the TEMPO is oxidized, building acidic environment, which allows the coloration of phenol red to magenta with its characteristic peak at 575 nm. The coloration from yellow to blue or magenta can occur at only their onset potential at −1.0V/+1.3V.

### Example 2(b): Multicolor ECD Based on Viologen

Multicolor viologen based ECD was produced by blending monoheptyl viologen (MHV) and ethyl viologen (EV) as electrochromic materials. These materials were chosen because the two viologen materials have a roughly 0.5V difference in onset potential and also because the blue color of EV and magenta color of MHV together are expected to display dramatic color change effect.

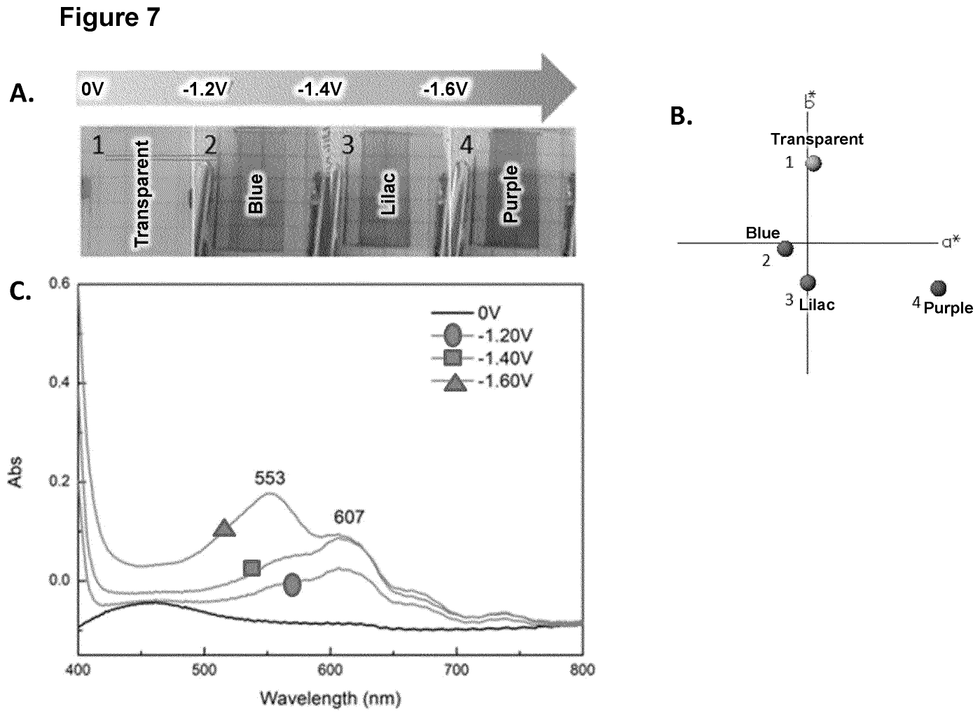

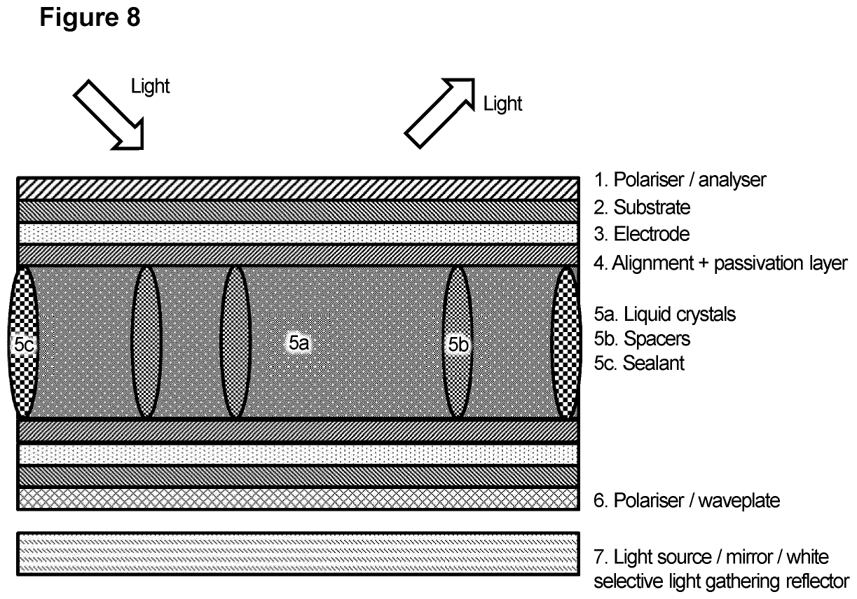

The optical property of the device was examined by UV-vis spectroscopy. The absorption spectra illustrate the characteristic peak at 606 nm with the blue-colored state of EV at −1.2V. Upon increasing the applied bias, the coloration of MHV+ occurred, changing its color to a deeper blue. At a potential of −1.6V, the reduction of MHV+ accelerates and the purple color appears on the device having a characteristic peak at 553 nm. The ECDs containing single EV2+ or MHV+ initiated their coloration at the onset potential of −0.88V or −1.25V respectively. It was therefore noted that the multi-color device requires a slightly higher (more negative) potential to drive the first and the second electrochromic behavior than the single color devices. It should be noted that the operational voltage plays a role in determining the color of the ECD. Photographs were taken and are shown in FIG. 7.

### Example 3: Polarization Color System Using LC

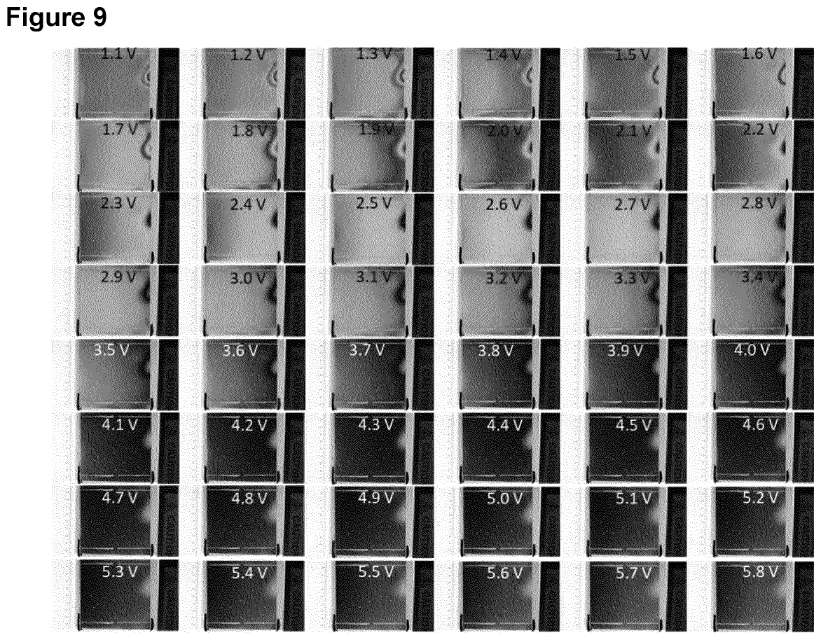

Into an empty cell—comprised of a sandwich of two glass substrates, each substrate with a 1×1 cm square electrode of ITO covered with an antiparallel-rubbed alignment layer—a droplet of a mixture of a liquid crystal “E7” was capillary filled. The ends of the now filled cell were sealed with epoxy resin, and then a polarizer and an analyser sheets were adhered to the outer top and bottom surfaces of the cell—these sheets were at crossed polarization to each other, and at 45° to the rubbing direction of the alignment layer of the cell. The cell was then placed on a white-light box to provide illumination. An AC 1 kHz square wave with 50%/50% duty cycle and no DC voltage offset, was applied to the cell; the amplitude of the voltage of the square wave was varied, and thus the color of the system perceived by the viewer was varied. Photographs were taken and are shown in FIG. 9.

### Example 4: Polarization Color System Using LC

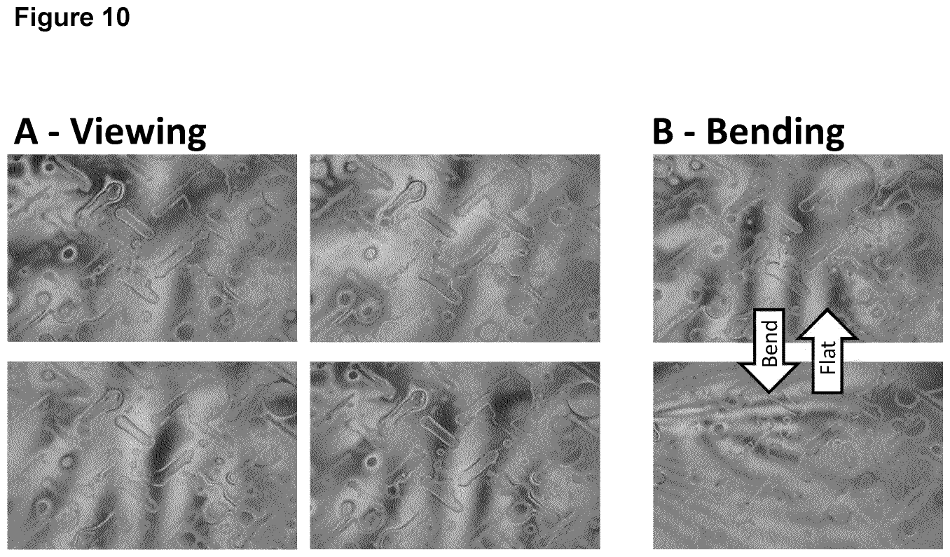

Into an empty cell—comprised of a sandwich of two polymer substrates, each substrate with a 10×10 cm square electrode of ITO, and a pattern of adhesive as a spacer—a droplet of a mixture of a liquid crystal “E7” was capillary filled. The ends of the now filled cell were sealed with the adhesive and kapton tape, and then the cell was placed between a polarizer and an analyser sheets. These polarizing sheets were at crossed polarization to each other, and at 45° to the dominant direction of the director of the LC within the cell. A white-light box was used to provide illumination and then the cell was observed under different viewing positions and/or bent by hand (from the flat state to a bent state with a bend of radius ˜10 cm) thus the color of the system perceived by the viewer was varied. Photographs were taken and are shown in FIG. 10.

The features of the present disclosure disclosed in the specification, the claims, and/or in the accompanying figures may, both separately and in any combination thereof, be material for realizing the disclosure in various forms thereof. Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, define, in part, the scope of the foregoing claim terminology such that no inventive subject matter is dedicated to the public.

1. Use of a system comprising stimulus-reactive component(s) or of liquid crystal material for color change,
wherein the color change is due to an external stimulus selected from
change of temperature,
change of voltage,
change of pressure,
change of bending,
change of viewing angle, and/or
movement.

2. The use according to claim 1, wherein said color change system is comprised in/on a device or object selected from:
a consumer product, in particular an item for personal use or consumption,
e.g. a piece of clothing, jewelry, wristwatch, dishware, shoes,
a part of a building or vehicle,
e.g. a window, in particular, a home window, shared house or office window, a car window; a wall, a ceiling, a floor, a pillar,
a piece of furniture,
e.g. a table, a chair, a desk, a stool, a bed, a shelf, a wardrobe,
a consumer electronic device,
e.g. a mobile phone, a computer, headphones, a speaker, a robotic device, a TV set, a stereo set, an electronic toy, a game console;
a household appliance,
e.g. dishwasher, washing machine, drying machine, an iron, a hairdryer, wherein, preferably, said color change is in/on at least one surface of said device or object, wherein, more preferably, said external stimulus is not exerted by said device or object or said external stimulus is exerted by said device or object.

3. The use of claim 1, wherein the stimulus is a change of temperature, wherein the color change system comprises
(i) thermochromic material,
such as thermochromic pigment(s) or ink(s), or thermochromic liquid crystal(s),
(ii) electro-to-thermal conversion element(s) or electro thermal agent(s), such as metal(s), e.g. wires or mesh,
(iii) a matrix, such as polymer(s), fabric(s), or resin(s),
(iv) optionally, a substrate.

4. The use of claim 3, wherein the color change is from a first color to a second color in a single step,
or wherein the color change is from one color to many color states/through intermediary color states, preferably by using different pigments.

5. The use of claim 3, wherein the color effect is homogenous or patterned.

6. The use of claim 3, wherein the (i) thermochromic material are selected from
leuco dye systems, such as spirolactones, fluorans, spiropyrans, and fulgides, as such or in polymeric capsules,
inorganic thermochromic pigments, such as titanium dioxide, zinc sulfide, zinc oxide, cuprous mercury iodide and silver mercury iodide,
or wherein the thermochromic liquid crystal(s) are cholesteric liquid crystal, e.g. cholesteryl nonanoate; or cyanobiphenyls,
wherein, preferably, said thermochromic materials are in the form of pigment powder, dispersion in solvent or granulates.
and/or wherein the (ii) electro-to-thermal conversion element(s) or electro thermal agent(s) are conductive/metal wires of micro or nano size, conductive/metal rods of micro or nano size, conductive/metal foil or mesh or conductive polymer(s),
such as
conductive/metal wires, rods, foil or mesh of CuSn, e.g. CuSn mesh, CuSn foil, CuSn wire, steel thread,
thin film heaters (TFH), e.g. silver nanowire, copper nanowire, conductive polymer poly(3,4-ethylenedioxythiophene)-poly(styrenesulfonate) (PEDOT:PSS).

7. The use of claim 3, wherein the thermochromic material (i), preferably thermochromic pigment(s) or ink(s), is embedded in a matrix (iii), wherein the matrix is a polymer matrix (such as poly(methyl methacrylate (PMMA), poly-di-methyl-siloxane (PDMS), styrene-base copolymer, polyurethane (PU)), and wherein preferably electro-to-thermal conversion element(s) or the electro thermal agent(s) (ii) are implemented in the thermochromic material/polymer matrix.

8. The use of claim 3, wherein the mixture of thermochromic material and polymer matrix is used as top-coat material for substrates,
wherein the substrate (iii) is non-conductive, such as glass, polyethylene terephthalate (PET), or wherein the substrate is conductive (iii), such as conductive fabric, metal plates, metal grids, metal mesh, glass or PET substrate with metal nanowires, glass or PET substrate with conductive polymer,
and/or wherein the surface of the substrate is rigid, planar, has curves or wherein the surface of the substrate is flexible.

9. A method for generating a color change system, which changes color due to a change of temperature, said color change system to be incorporated in a device or object as defined in claim 2, said method comprising,
(a) mixing a thermochromic material, or thermochromic liquid crystal(s) with a matrix, preferably a polymer matrix,
(b) coating a substrate, with the mixture obtained in step (a),
wherein the substrate is a conductive substrate or a substrate coated with a conductive material, preferably a thin film heater (TFH) as defined in claim 5, wherein the substrate forms part of the device or object.

10. A method for generating a color change system, which changes color due to a change of temperature, said color change system to be incorporated in a device or object as defined in claim 2, said method comprising,
(a) mixing a thermochromic material, or thermochromic liquid crystal(s),
with a matrix, preferably a polymer matrix,
(b) adding electro-to-thermal conversion element(s) or the electro thermal agent(s) to the mixture obtained in step (a),
(c) optionally, coating a substrate with the mixture obtained in step (b), wherein
the substrate forms part of the device or object.

11. The use of claim 1, wherein the stimulus is a change of voltage
and wherein the color change system comprises an electrochromic cell or an electrochromic device (ECD),
and wherein the color change comprises opacity change,
wherein the ECD preferably comprises:
at least one electrochromic (EC) layer,
an electrolyte layer,
two (transparent) conducting electrodes,
wherein the electrodes can be glass or polyethylene terephthalate (PET), each coated with indium tin oxide (ITO) and/or other doped metal oxide(s).

12. The use of claim 11, wherein the color effect is homogenous from color 1 to color 2 or multiple colors (color 1 to color 2 to color 3 or more) or patterned.

13. The use of claim 11, wherein the at least one EC layer comprises
(i) conductive polymer(s),
such as poly(3,4-ethylenedioxythiophene)-poly(styrenesulfonate) (PEDOT:PSS)-based materials,
optionally mixed with one or more metal-complex pigment(s), or
optionally as an electrochromic layer in a multi-layer stack, or
(ii) small organic molecule(s),
such as viologen,
e.g. alkyl-substituted viologens
monoheptyl viologen hexafluorophosphate [MHV(PF6)],
diheptyl viologen bis-(hexafluorophosphate) [DHV(PF6)2],
ethyl viologen bis-(hexafluorophosphate) [EV(PF6)2],
or combinations thereof, such as DHV(PF6)2 and MHV(PF6)2
aryl-substituted viologens or EV(PF6)2 and MHV(PF6)2.

14. The use of claim 11, wherein the at least one EC layer comprises (i) conductive polymer(s) and the system has a vertical structure or a co-planar structure,
said vertical structure comprising from top to bottom:
an (transparent) conducting electrode,
an EC layer,
a spacer, preferably a bi-adhesive spacer,
an electrolyte layer,
an EC layer, and
an (transparent) conducting electrode,
or
said co-planar structure comprising from top to bottom
a substrate,
an electrolyte layer,
a spacer, preferably a bi-adhesive spacer,
an EC layer,
a layer containing (transparent) conducting electrodes, and
a substrate.

15. The use of claim 11, wherein the at least one EC layer comprises (ii) viologen(s) and the system furthermore comprises
an anodic species,
such as ferrocene (Fc),
an ionic liquid,
such as 1-ethyl-3-methylimidazolium bis(trifluoromethylsulfonyl)imide ([EMI][TFSI]), 1-ethyl-3-methylimidazolium tetrafluoroborate ([EMI][BF4]), a copolymer,
such as poly(vinylidene fluoride-co-hexafluoropropylene) (PVDF-co-HFP), wherein preferably a mixture of the copolymer, the ionic liquid, the viologen (such as DHV(PF6)2 or MHV(PF6)2 or EV(PF6)2 and the anodic species (such as dmFc) are cast onto a substrate, preferably an ITO-coated substrate, and another substrate, preferably an ITO-coated substrate, is placed on top.

16. The use of claim 11, wherein the surface of the substrate is rigid, planar, has curves or wherein the surface of the substrate is flexible.

17. The use of claim 1, comprising the use of liquid crystal (LC) materials,
preferably in a device stack comprising polarizer(s), substrate(s), electrode(s), alignment layer(s) and LC material(s).

18. The use of claim 17, for generating fluid color or rainbow or stained-glass effects.

19. The use of claim 17, wherein the color change is performed by applying a voltage with a modulated waveform,
wherein preferably shape, amplitude, and/or frequency of the waveform is modulated.

20. The use of claim 18, wherein a device stack of a LC cell has the following layer structure from top to bottom:
(i) polarizer/analyser,
(ii) substrate, such as glass, silicone, plastic (e.g. PET),
(iii) electrode, such as ITO, ICP (e.g. PEDOT:PSS),
(iv) alignment layer, optionally alignment and passivation layer,
(v) LC material layer,
optionally comprising spacers and/or sealant,
(vi) electrode, such as ITO, Al, Ag, ICP (e.g. PEDOT:PSS),
(vii) substrate, such as glass, silicone, plastic (e.g. PET),
(ix) polarizer/waveplate, and
(x) light source or mirror or white selective reflection light gathering,
wherein the LCs in said LC material layer (v) have the following characteristics:
being birefringent;
having positive or negative dielectric anisotropy;
being a mixture of molecules or a single molecule;
their phase is nematic or smectic or chiral or blue or discotic or columnar or conic or isostropic, or selectable between phases;
the LC class is thermotropic, lyotropic or metallotropic; and
the directors of the LC in the layer are random, vertical, parallel, bent, or twisted.

21. The use of claim 17, wherein one device stack is a single pixel,
and/or wherein one device stack is conformable.

22. The use of claim 17, wherein the alignment layer creates patterns,
and/or comprising different alignment of LCs within an area in the cm² range.

23. The use of claim 17, wherein color effects are obtained by one or more of the following:
different LC material,
type of polarizer (linear or circular),
direction of top and bottom polarizers (co-linear, crossed or at some angle relative to each other in-between),
spacing between two electrodes or varying the LC cell gap in different parts of the LC cell, e.g. via the use of different sized spacers,
varying the alignment layer strength/direction/presence in different parts of the LC cell, e.g. via the use of different alignment materials, and/or different rubbing directions, and/or different deposition/processing/curing (e.g. polarization directions) conditions,
varying the retardation of the LC via changing the electric field in the LC layer,
varying the phase of the LC e.g. nematic to isotropic, or nematic to smectic,
batik designs using sealant and/or spacers in the active LC cell area,
varying the polarization/wave-plate retardation to create patterns,
cm² range also includes mm² range (fine patterning also possible),
the viewing angle of the observer caused by the observer moving relative to the LC cell.

24. The use of claim 17, furthermore comprising a sensor and/or a microcontroller to trigger the color change function, and/or the color switching procedure is controllable via Bluetooth.

25. The use of claim 1, wherein said color change occurs at a rate, wherein said rate is fixed or wherein said rate is variable.

26. A device or object selected from:
a consumer product,
a part of a building or vehicle,
a piece of furniture,
a consumer electronic device,
a household appliance,
wherein said device or object comprises a color change system as defined in claim 1.

27. The device or object of claim 26, wherein a color change is due to an external stimulus selected from
change of temperature,
change of voltage,
change of pressure,
change of bending,
change of viewing angle, and/or
movement,
